(19) United States
(12) Patent Application Publication
(10) Pub. No.: US 2014/0359114 A1
(43) Pub. Date: Dec. 4, 2014

(54) COMPUTER-READABLE RECORDING MEDIUM, USAGE MODE DATA GENERATION METHOD, AND USAGE MODE DATA GENERATION DEVICE

(71) Applicant: FUJITSU LIMITED, Kawasaki-shi (JP)

(72) Inventors: Hiroshi Takamure, Numazu (JP); Yoshitaka Kizuka, Fuji (JP); Yusuke Hara, Yokohama (JP); Mayuko Morita, Yokohama (JP)

(73) Assignee: FUJITSU LIMITED, Kawasaki-shi (JP)

(21) Appl. No.: 14/256,437

(22) Filed: Apr. 18, 2014

(30) Foreign Application Priority Data
May 31, 2013 (JP) 2013-115982

(51) Int. Cl. H04L 12/26; H04L 12/24

(52) U.S. Cl. CPC H04L 43/0876; H04L 41/26
USPC 709/224

(57) ABSTRACT

A computer-readable recording medium has stored therein a program for causing a computer to execute a usage mode data generation process. The process comprising (a) reading from a storage device association data associating each of a plurality of different expression formats of component data and a standardized expression format which can be converted to each of the plurality of different expression formats, and (b) based on the association data read at (a), generating according to the standardized expression format standardized usage mode data containing component data from first usage mode data that is usage mode data for a first virtual computer included in a plurality of virtual computers and that contains component data for the connector in a first relay device with the type of a first type expressed in a first expression format corresponding to the first relay device.

### CROSS-REFERENCE TO RELATED APPLICATION

This application is based upon and claims the benefit of priority of the Japanese Patent Application No. 2013-115982, filed on May 31, 2013, the entire contents of which are incorporated herein by reference.

### FIELD

The present invention relates to a computer-readable recording medium, usage mode data generation method, communication system, and usage mode data generation device.

### BACKGROUND

As illustrated in FIG. 14, virtual machines (VM) have hitherto been provided, for example to 4 respective servers 302-1 to 302-4 that are each connected to 4 ports 303-1 to 303-4 of a switch 300. FIG. 14 illustrates an example in which a virtual machine 304-1 is provided to the server 302-1, and a virtual machine 304-4 is provided to the server 302-4. Communication occurs between the virtual machine 304-1 and the virtual machine 304-4 through the switch 300. When virtual machines are also provided to the server 302-2 and the server 302-3, communication occurs between the virtual machines provided to the server 302-2 and the server 302-3 through the switch 300. Consider a case in which the virtual machine 304-1 only communicates with the virtual machine 304-4. Since the 4 servers 302-1 to 302-4 are connected to the single switch 300, data from the virtual machine 304-1 might sometimes be transmitted to the virtual machine provided to the server 302-3 that is not the transmission destination.

In order that data is not transmitted from one virtual machine to another virtual machine that is not the transmission destination, consideration may be given to building 2 networks by providing 2 switches and only connecting the servers with mutually communicating virtual machines to each of the switches. Namely, consideration may be given to building a first network including the server 302-1, one of the switches, and the server 302-4, and a second network including the server 302-2, the other of the switches, and the server 302-3. However, providing 2 switches increases the complexity of the overall configuration.

Hitherto, 2 networks have been built virtually by using the switch 300 by employing virtual separation in the switch 300. Virtually built networks are referred to as Virtual Local Area Networks (VLAN). 2 virtual local area networks are respectively identified by Virtual Local Area Network Identifiers (VLAN ID).

In order to build two virtual local area networks, virtual local area network identifiers of identification data of the 4 respective ports 303-1 to 303-4 are stored in memory, not illustrated in the drawings, of the switch 300. The memory of the switch 300 is moreover stored with Media Access Control Addresses (MAC Addresses) that are used in communication between the virtual machines associated with the virtual local area network identifiers. For example, the memory is stored with X as a virtual local area network identifier associated with the respective identification data of the ports 303-1, 303-4, and stored with Y as the MAC address used in communication between the virtual machines 304-1, 304-4. N is moreover stored as the virtual local area network identifier associated with the ports 303-2, 303-3, and M is stored as the MAC address employed in communication by the virtual machines provided to the servers 302-2 and the 302-3.

Accordingly, for example when communication is performed between the virtual machines 304-1, 304-4, the switch 300 identifies the communication between the virtual machines 304-1, 304-4 with the MAC address (Y). The switch 300 moreover identifies the ports 303-1, 303-4 performing communication between the virtual machines 304-1, 304-4 with the virtual local area network identifier (X). When communication is performed between the virtual machines 304-1, 304-4, the switch 300 only relays data between the virtual machines 304-1, 304-4. Namely, the switch 300 does not transmit data transmitted from the virtual machine 304-1 to the virtual machine associated with the port 303-3 that is appended with the other virtual local area network identifier (N).

As described above, the memory of the switch 300 is stored with the virtual local area network identifiers associated with the identification data each of the ports 303-1 to 303-4, and the MAC addresses used in communication between the virtual machines. The virtual local area network identifiers and MAC addresses associated with identification data of the respective ports 303-1 to 303-4 stored in the memory are referred to as port profiles. The switch 300 relays communication between the virtual machines using the port profiles stored in the memory, thereby building a virtual local area network. The virtual local area network identifiers are used in virtual local area network building.

As illustrated in FIG. 14, the virtual machine 304-1 of the server 302-1 is sometimes migrated (relocated) to the separate server 302-2. There is a need to prevent transmission of data from the virtual machine 304-1 to virtual machines other than the virtual machine 304-4, that are not the transmission destination, after the virtual machine 304-1 has migrated to the server 302-2. There is therefore a need to maintain the virtual local area network including the virtual machine 304-1 and the virtual machine 304-4. The port profile associated with the identification data of the port 303-1 accordingly must be stored in the memory of the switch 300 in association with the identification data of the port 303-2. Hitherto, when there is some degree of expectation of migration of the virtual machine 304-1 to the server 302-2, the port profile associated with the identification data of the port 303-1 is stored in association with the identification data of the port 303-2 in the memory of the switch 300. However, it is cumbersome to store the port profiles in advance. Accordingly, a function has been used in switches to automatically store port profiles associated with the identification data of the switches to be connected to the migration destination server of the virtual machine accompanying virtual machine migration (Automatic Port Profile Migration (AMPP)). Namely, the virtual machine 304-1 outputs a virtual local area network identifier (10) to the switch 300 during communication through the switch 300 of the virtual machine 304-1 that has migrated to the server 302-2 with the virtual machine 304-4. The switch 300 automatically stores in the memory a port profile including the virtual local area network identifier (10) associated with the identification data of the port 303-2 to which the server 302-2 is connected.

A larger network can be configured by connecting one switch to another switch. For example, as illustrated in FIG. 15, the switch 300 is connected to a switch 400. When the switch 300 is connected to the switch 400, the virtual machine 304-1 of the server 302-1 that is connected to the switch 300 can migrate to a server 402-1 that is connected to port 403-1 of the switch 400. In order to maintain the virtual local area network, even after migration of the virtual machine 304-1 to the server 402-1, the port profile is still stored associated with the port 403-1 in memory of the switch 400.

The switches 300, 400 may be connected together even when the switch 300 and the switch 400 are manufactured by different vendors (manufacturers).

### RELATED PATENT DOCUMENTS

Patent Document 1: Japanese Patent Application Laid-Open (JP-A) No. 2003-219029

Patent Document 2: JP-A No. 2009-32204

### SUMMARY

According to an aspect of the embodiments, a computer-readable recording medium, having stored therein a program for causing a computer to execute a usage mode data generation process, the process comprising:

(a) reading from a storage device association data associating each of a plurality of different expression formats of component data and a standardized expression format which can be converted to each of the plurality of different expression formats, each of the plurality of different expression formats corresponding to each type of a plurality of relay devices, the plurality of relay devices having a connector and relaying communication through the connectors between a plurality of virtual computers that each operate on a data processing device, the component data being included in a usage mode data which is referenced by the relay device, the usage mode data being data to set a usage mode of the connector when the communication through the connectors between a plurality of virtual computers; and

(b) based on the association data read at (a), generating, according to the standardized expression format, standardized usage mode data containing component data from first usage mode data that is usage mode data for a first virtual computer included in the plurality of virtual computers and that contains component data for the connector in a first relay device with the type of a first type expressed in a first expression format corresponding to the first relay device.

It is to be understood that both the foregoing general description and the following detailed description are exemplary and explanatory and are not restrictive of the invention.

### BRIEF DESCRIPTION OF DRAWINGS

FIG. 1 is a block diagram illustrating an example of a communication system of an exemplary embodiment;

FIG. 2 is a functional block diagram of a management device 10 of an exemplary embodiment;

FIG. 3 is a diagram schematically illustrating an example of a management process of a management program stored in ROM 34 of the management device 10.

FIG. 4A is a diagram illustrating a flow of processing during generation of port profiles in the formats of a vendor B and a vendor C, from a port profile in the format of a vendor A; FIG. 4B is a flow chart illustrating an example of a processing flow at step S1-1 of FIG. 4A.

FIG. 5 is a diagram illustrating rules defined for generating a port profile from a master port profile and vice versa and associated with respective switch models and OSs.

FIGS. 6A and 6B are diagrams explaining rules for generating a port profile of a different format from a port profile of a particular format; FIG. 6A illustrates rules for generating port profiles of all other formats from the port profile of a particular format; FIG. 6B is a diagram illustrating rules for generating a master port profile from all port profiles of differing formats and vice versa.

FIG. 7 is a flow chart illustrating an example of a processing flow for generating a port profile from a master port profile of the exemplary embodiment.

FIG. 8 is a diagram illustrating VM migration.

FIG. 9A to FIG. 9C are diagrams illustrating port profile contents during generation of a port profile of the format of a vendor B from a port profile of the format of a vendor A; FIG. 9A illustrates a port profile PPA in the format of the vendor A; FIG. 9B illustrates a port profile PPB in the format of the vendor B; FIG. 9C illustrates a master port profile generated from the port profile PPA.

FIG. 10 is a diagram illustrating an association table of port profiles against VMs stored in a switch.

FIG. 11 is a diagram illustrating a priority ranking input by a priority ranking input section 70;

FIG. 12 is a diagram explaining selection of QoS identification data that is closest to a QoS in a switch 22-1 from QoS identification data stored in a switch 22-2, in accordance with the priority ranking of FIG. 11.

FIG. 13 is a diagram illustrating a correspondence relationship between port profiles used by VMs migrated to a server 14 connected to a switch 22-2 from a server 12 connected to a switch 22-1, and MAC addresses used in communication with the VMs; explaining a case in which a VM 17 is migrated ((A)); and explaining a case in which a VM 19 is migrated following the VM 17 migration ((B)).

FIG. 14 is a diagram illustrating VM migration in related art.

FIG. 15 is a diagram illustrating migration of a VM of a server connected to a particular switch to another server connected to a different switch in related art.

### DESCRIPTION OF EMBODIMENTS

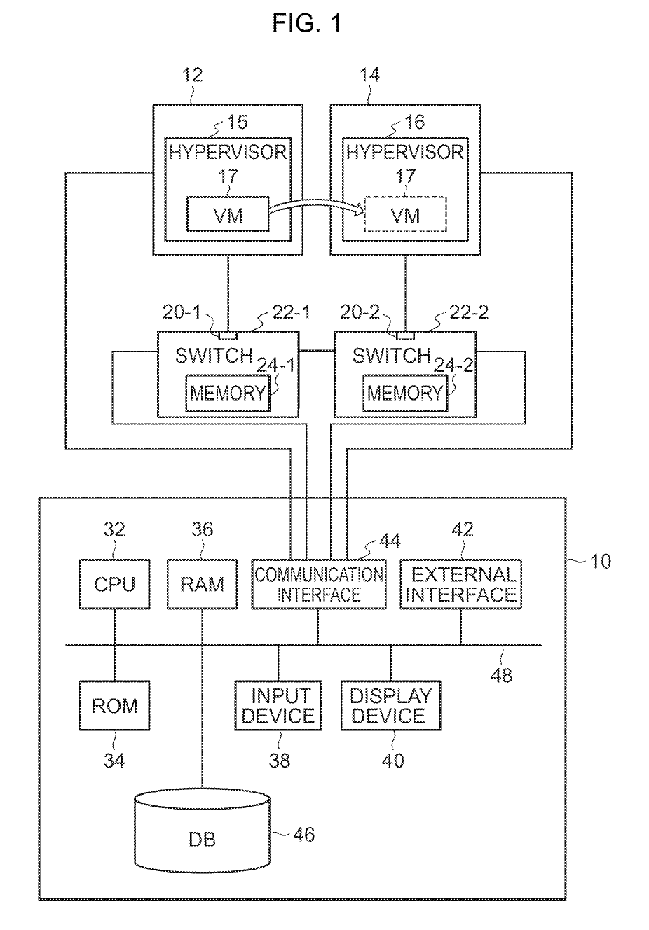

Detailed description follows regarding an example of an exemplary embodiment of the present invention with reference to the drawings. Explanation follows regarding configuration of the exemplary embodiment. In the communication system illustrated in FIG. 1, a server 12 is connected to a port 20-1 of a switch 22-1, and a server 14 is connected to a port 20-2 of a switch 22-2. The servers 12, 14, the switch 22-1, and the switch 22-2 are connected to a management device 10.

A virtual machine (referred to as “VM” below) 17 is provided to the server 12. Moreover, a hypervisor 15 operates on the server 12 and controls the VM 17. As described below, the VM 17 is migrated (moved) to the server 14. A hypervisor 16 operates on the server 14, and the hypervisor 16 controls the VM 17 on the server 14 after the VM 17 has been migrated to the server 14.

The server 12 communicates with for example another server connected to a switch 22-1, not illustrated in the drawings, and the server 14 that is connected to the switch 22-2, through the VM provided to each server.

In the management device 10, a Central Processing Unit (CPU) 32, Read Only Memory (ROM) 34, Random Access Memory (RAM) 36, an input device 38, and a display device 40 are mutually connected to each other through a bus 48. An external interface 42, a communication interface 44 and a database 46 are connected to the bus 48.

The servers 12, 14 are configured similarly to the management device 10 and description of the configuration of the servers 12, 14 is therefore omitted. The switches 22-1, 22-2 are of similar configuration to the management device 10; however, the configurations of the switches 22-1, 22-2 differ from the configuration of the management device 10 in that the switches 21, 22-2 are not provided with the input device 38 and the display device 40 of the management device 10. Moreover, the configurations of the switches 22-1, 22-2 differ from the configuration of the management device 10 in that the switches 22-1, 22-2 are respectively provided with memories 24-1, 24-2 in place of the database 46 of the management device 10.

Note that the management device 10 serves as an example of a usage mode data generation device of the present invention, and the servers 12, 14 serve as examples of a data processing device of the present invention. Moreover, the switches 22-1, 22-2 serve as examples of a relay device of the present invention, and the ports 20-1, 20-2 serve as examples of a connector of the present invention. The memories 24-1, 24-2 serve as examples of an association memory of the present invention. The VM 17 serves as an example of a virtual computer of the present invention.

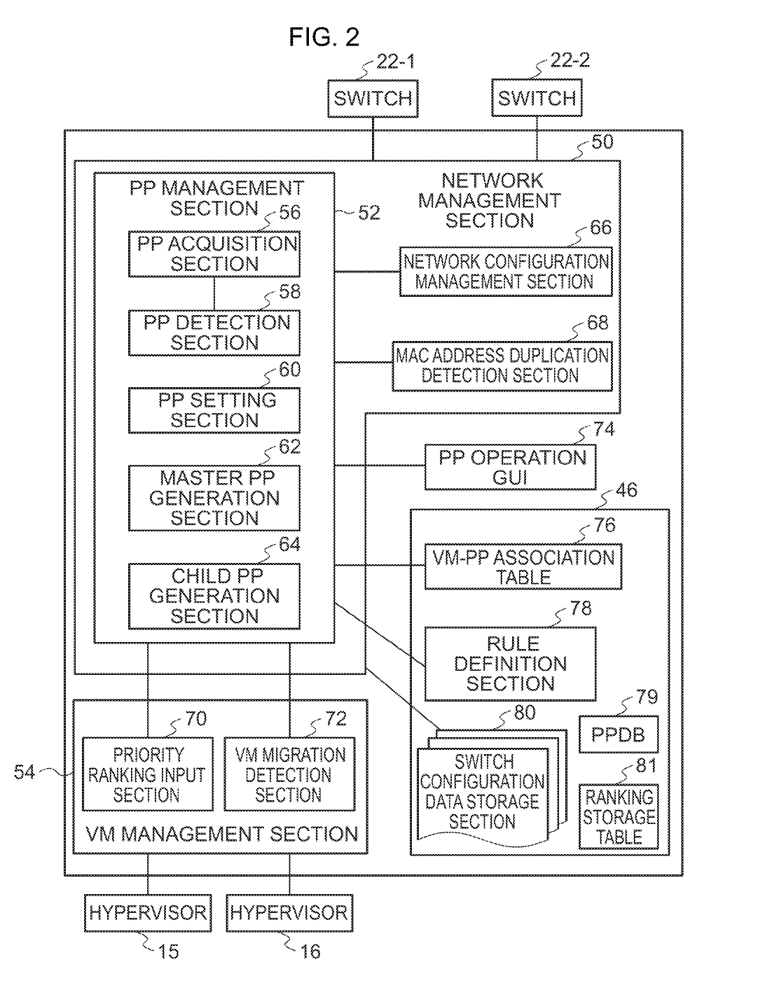

FIG. 2 illustrates a functional block diagram of the management device 10. The management device 10 is provided with a network management section 50 and a VM management section 54. Moreover, the management device 10 is provided with a PP (Port Profile), an operation Graphical User Interface (GUI) 74, and the database 46.

The network management section 50 is provided with a PP management section 52, a network configuration management section 66, and a Media Access Control (MAC) address duplication detection section 68. The PP management section 52 is provided with a PP acquisition section 56, a PP detection section 58, a PP setting section 60, a master PP generation section 62, and a child PP generation section 64.

The VM management section 54 is provided with a priority ranking input section 70 and a VM migration detection section 72. The database 46 is provided with a VM-PP association table 76, a rule definition section 78, a PP database (referred to as a PPDB (Port Profile Data Base) below) 79, a switch configuration data storage section 80, and a ranking storage table 81.

The management device 10 performs VM management, network management, and port profile unified management. The network management section 50 performs setting and monitoring of the switch 22-1 and the switch 22-2. The PP acquisition section 56 acquires a port profile stored in the switches 22-1, 22-2. When for example the VM 17 has been migrated from the server 12 to the server 14, the PP detection section 58 checks whether or not the port profile attempting to be newly created at the VM 17 migration destination side switch 22-2 is already present in the memory 24-2 of the switch 22-2. The PP setting section 60 stores (sets) the port profile in the memory 24-2 of the switch 22-2. When for example a port profile has been created, the master PP generation section 62 automatically creates a master port profile. The child PP generation section 64 creates a port profile for each of the ports 20-1, 20-2 of the respective switches 22-1, 22-2. The network configuration management section 66 reads the hypervisor and switch data stored in the switch configuration data storage section 80 and detects the switches on the VM migration source side and the VM migration destination side. The MAC address duplication detection section 68 checks whether or not the MAC address communicated by the migrating VM is already in use at the switch at the migration destination side.

The VM management section 54 performs VM creation, VM erasure, VM migration and the like through the hypervisors 15, 16. The priority ranking input section 70 inputs a priority ranking in accordance with user instructions when one of identification data is chosen from plural Quality of Service (QoS) identification data, described below, of the migration destination switch. The input priority ranking is stored in the ranking storage table 81 (see also FIG. 11). The VM migration detection section 72 detects VM migration.

The PP operation GUI 74 inputs data for port profile creation in accordance with formats of the switches 22-1, 22-2.

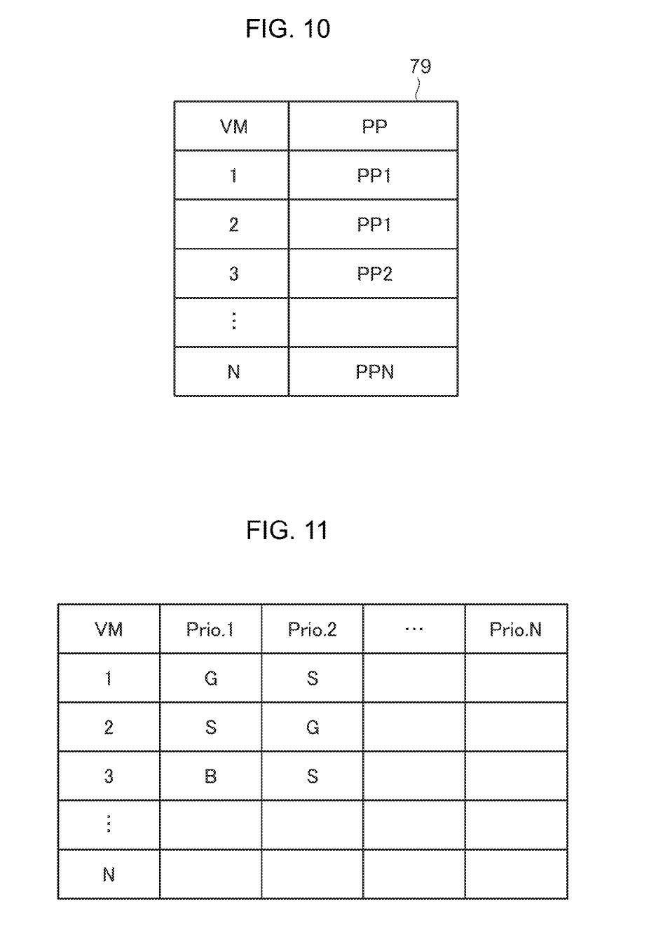

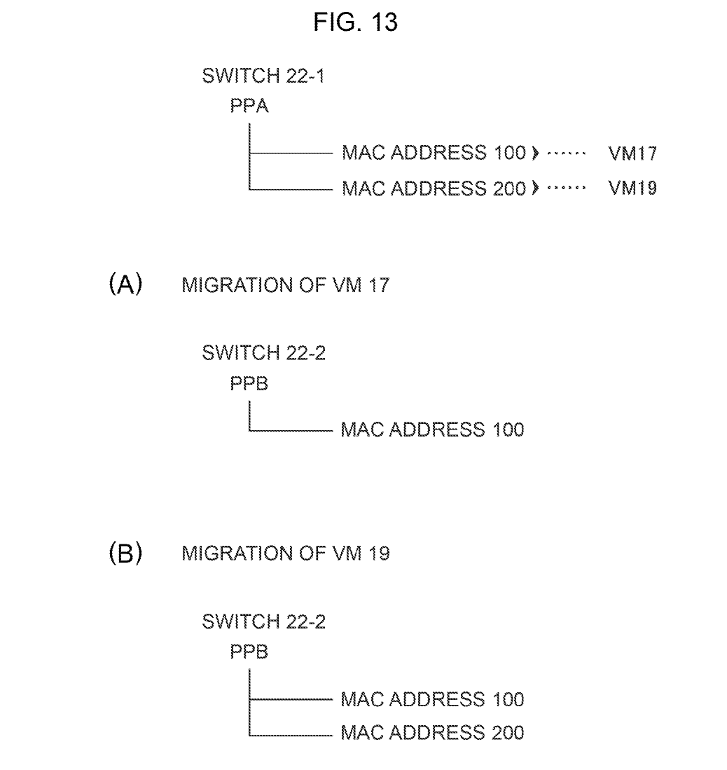

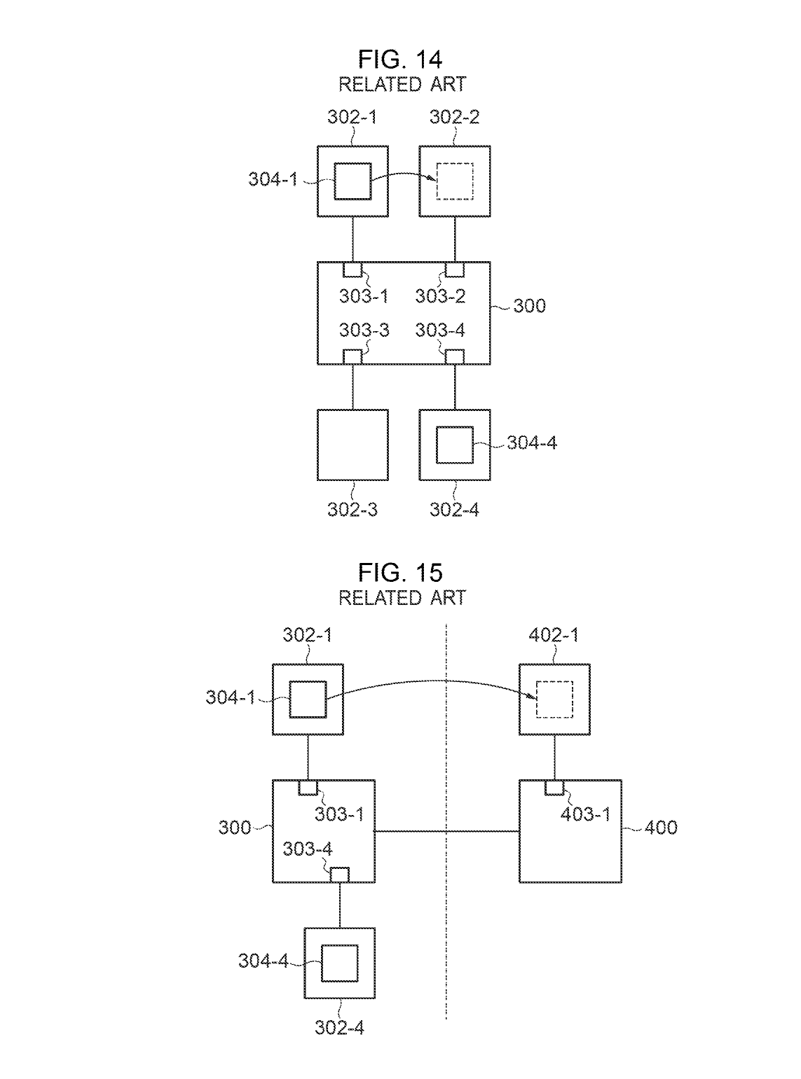

The VM-PP association table 76 is used to manage the port profiles and VM data using each port profile. The rule definition section 78 stores rules, described in detail below, that are required for the creation of the port profiles and the master port profile. The PPDB 79 stores the port profiles managed in the database 46. Note that each port profile corresponds to a switch and is stored associated with a VM as illustrated in FIG. 10. To be more specific, as illustrated in FIG. 13 the port profile PPA is stored associated with the MAC addresses (100, 200) for communication using the VMs 17, 19. The models of the switches 22-1, 22-2, the OS used by the switches 22-1, 22-2 and data indicating the hypervisors 15, 16 associated with the switches 22-1, 22-2 are stored in the switch configuration data storage section 80, associated with the switches 22-1, 22-2.

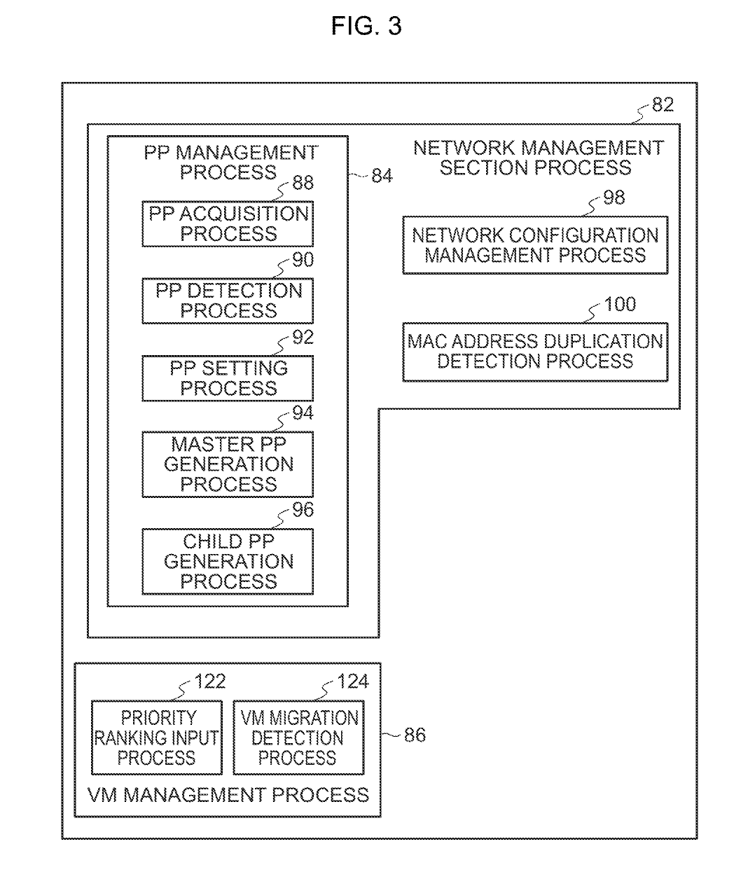

An example of a management process performed by a management program stored in the ROM 34 of the management device 10 is schematically illustrated in FIG. 3. The CPU 32 reads the management program from the ROM 34, expands the management program into the RAM 36, and executes processes of the management program. The management process is provided with a network management section process 82, and a VM management process 86. The network management section process 82 is provided with a PP management process 84, a network configuration management process 98, and a MAC address duplication detection process 100. The PP management process 84 is provided with a PP acquisition process 88, a PP detection process 90, a PP setting process 92, a master PP generation process 94, and a child PP generation process 96. The VM management process 86 is provided with a priority ranking input process 122 and a VM migration detection process 124.

Note that an example of a case where the management program is read from the ROM 34 is given above; however, there is no requirement for the management program to be stored in the ROM 34 from the outset. The management program may, for example, be initially stored on any “portable recording medium” such as a Solid State Drive (SSD), a DVD disc, an IC card, a magneto-optical disc, or a CD-ROM connected to and used by the management device 10. Furthermore, the management device 10 may be configured to acquire and execute the management program from a portable recording medium. Moreover, the management program may be stored in a storage section such as another computer or a server device connected to the management device 10 through a communication line. The management device 10 may for example acquire and execute the management program from another computer or server device.

Note that by executing each of the processes 82 (84 (88 to 96), 98, 100), 86 (122, 124), the CPU 32 operates as each of the sections 50 (52 (56 to 64), 66, 68), 54 (70, 72) that are illustrated in FIG. 2.

Note that the rule definition section 78 serves as an example of a storage device of the present invention, the master PP generation section 62 serves as an example of a standardized usage mode data generation section of the present invention, and the child PP generation section 64 serves as an example of an individual usage mode data generation section of the present invention.

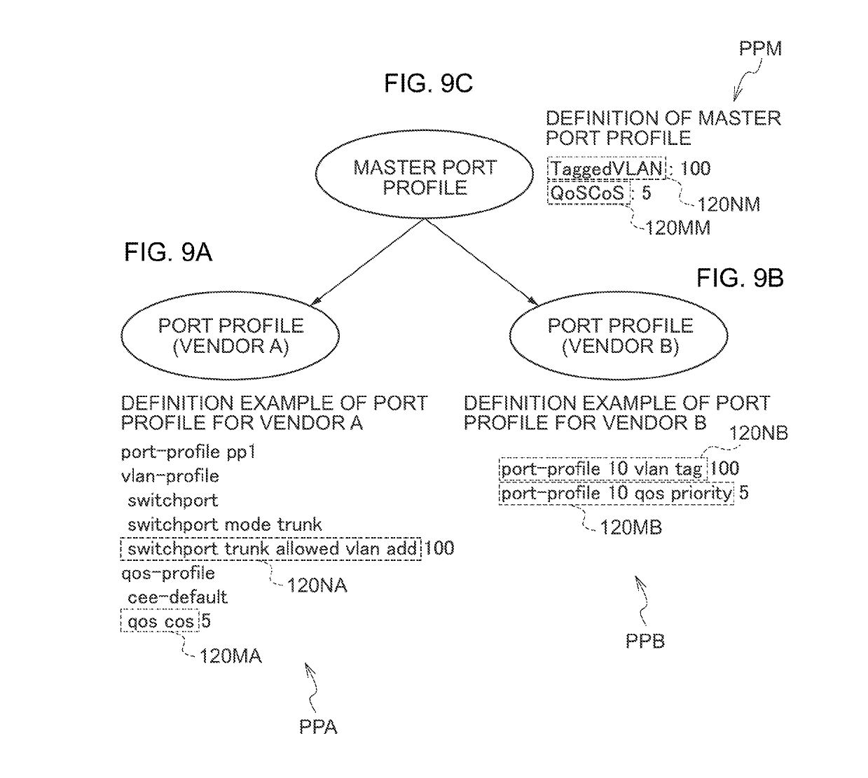

Description of the operation of the exemplary embodiment follows. As illustrated in FIG. 1, a case is considered in which the VM 17 is provided to the server 12, and the VM 17 is in communication other VMs. The user uses the PP operation GUI 74 and inputs data for creating a port profile associated with the VM 17. The vendor of the switch 22-1 that is connected to the server 12 is a vendor A. The child PP generation section 64 creates the port profile PPA (see (A) in FIG. 9) based on the input data using the formats of the vendor A. The PP setting section 60 stores the generated port profile PPA to the memory 24-1 of the switch 22-1 associated with the identification data of the port 20-1 connected to the server 12.

The switch 22-1 relays communication between the VM 17 of the server 12 and another VM, through the port 20-1 that is connected to the server 12. The switch 22-1 relays communication in accordance with a port profile that sets the usage mode of the port 20-1. A virtual local area network that includes the VM 17 and the other VM is accordingly built. An example of an element that defines the usage mode included in the port profile is data indicating the virtual local area network identifier (referred to below as the VLAN ID). The port profile further includes for example data specifically indicating contents of the network service, for example the QoS associated with data expressing the QoS, as another example of such an element.

As described above, the vendors of the respective switches 22-1, 22-2 are different, and the port profile formats of the switches 22-1, 22-2 are therefore also different. Namely, the port profile PPA associated with the switch 22-1 vendor A is illustrated in (A) in FIG. 9. As illustrated in (A) in FIG. 9, the expression format of the data indicating the VLAN ID is “switchport trunk allowed vlan add” as indicated by reference numeral 120NA. The expression format indicating the QoS is “qos cos” as shown by the reference numeral 120MA. A port profile PPB that corresponds to a switch 22-2 vendor B is illustrated in (B) in FIG. 9. As illustrated in (B) in FIG. 9, the expression format of the data indicating the VLAN ID is “port-profile 10 vlan tag” as indicated by reference numeral 120NB. The expression format of the data indicating the QoS is “port-profile 10 qos priority” as indicated by the reference numeral 120MB.

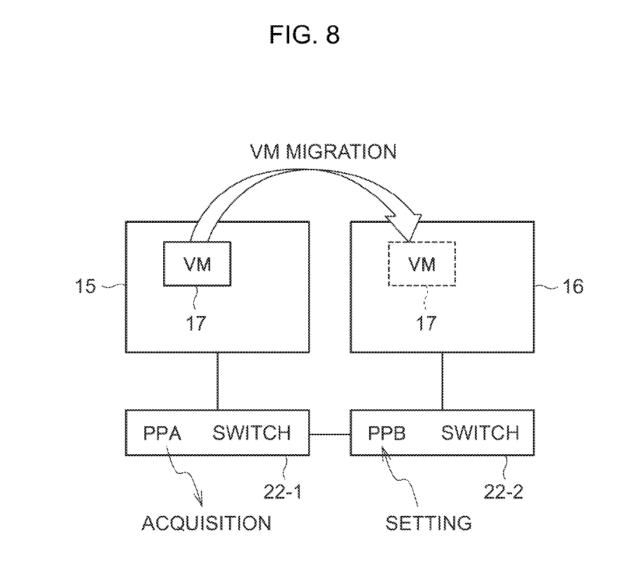

The expression formats expressing data that defines the usage mode elements of the port profile vary by vendor. Thus, when the VM 17 of the server 12 is migrated to the server 14 as illustrated in FIG. 1 and FIG. 8, the switch 22-2 is unable to use the port profile PPA with the format left as it is.

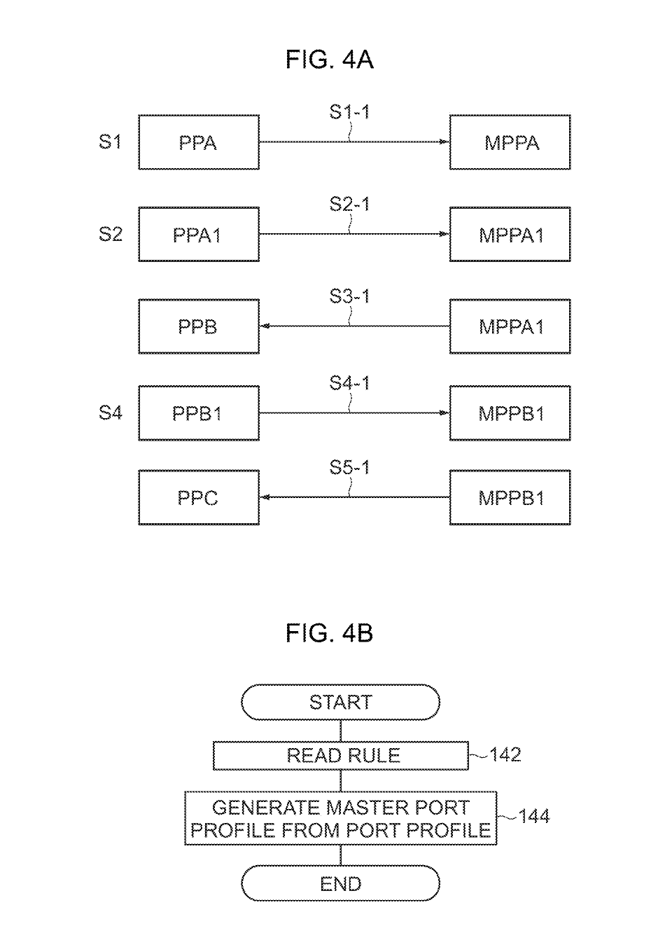

When the port profile PPA has been created (see Si of FIG. 4A), at step S1-1 the master PP generation section 62 generates a master port profile MPPA from the port profile PPA that uses the vendor A formats.

In the exemplary embodiment, rules for the generation of the master port profile MPPA from the port profile PPA that uses the vendor A format are pre-stored in the rule definition section 78. Namely, since the expression formats that indicate data that defines each element of the usage modes of ports 20-1, 20-2 are different for the vendors A, B, the expression formats of each element in the management device 10 are therefore standardized; namely, compatible standardized expression formats are pre-defined. The rules indicate which expression formats correspond to which standardized expression formats. Note that the standardized expression formats serve as an example of a standardized expression format of the present invention.

The operator associates together “switchport trunk allowed vlan add” (120NA) and “port-profile 10 vlan tag” (120NB), and defines “TaggedVLAN” (120NM) as the standardized expression format corresponding thereto. The operator defines a first rule stating that “switchport trunk allowed vlan add” and “port-profile 10 vlan tag” correspond to “TaggedVLAN”. Moreover, the operator defines “QoSCoS” (120MM) as the standardized expression format corresponding to “qos cos” (120MA) and “port-profile 10 qos priority” (120MB). The operator defines a second rule stating that “qos cos” and “port-profile 10 qos priority” correspond to “QoSCoS”. The first rule and the second rule defined above are stored in the rule definition section 78.

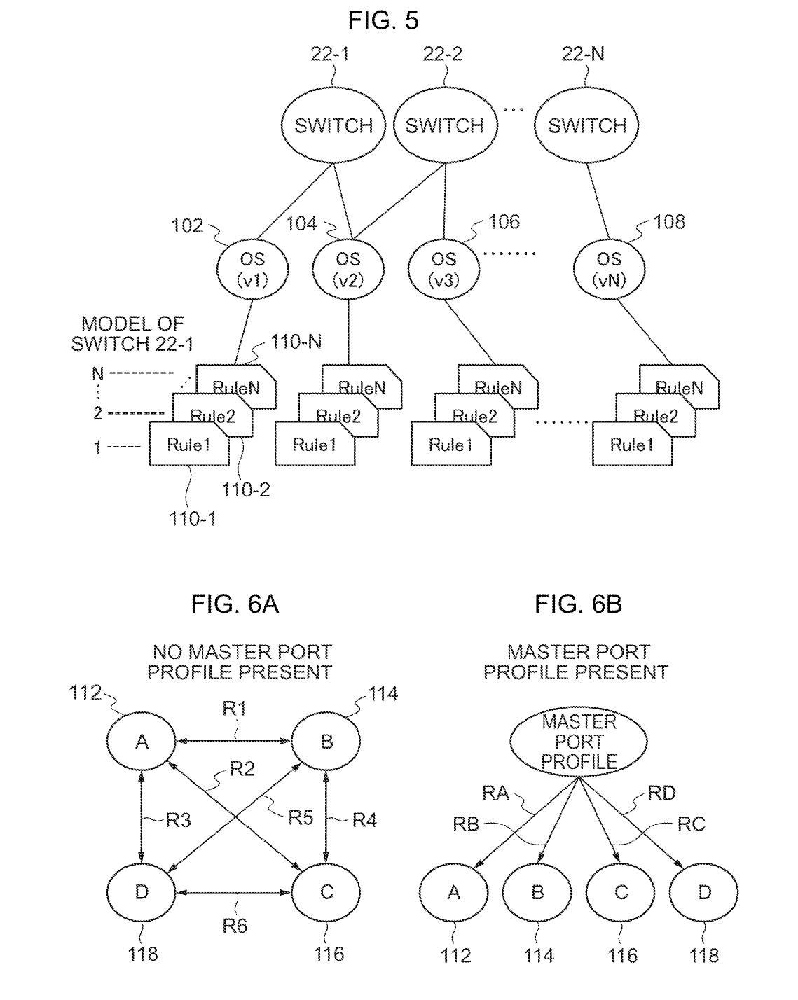

An example is described above wherein the expression formats of the port profiles differ between each vendor. However, the expression formats of the port profiles also differ for each switch model and Operating System (OS) used by each switch. Rules that differ between each switch model and each OS for generating the master port profile from the port profiles of each switch are stored in the rule definition section 78 for each switch model and each OS. As illustrated in FIG. 5, rules 110-1, 110-2 . . . 110-N, used by the switch 22-1 for the purpose of generating a master port profile corresponding to switch 22-1, are stored in the rule definition section 78. The rules 110-1, 110-2 . . . 110-N correspond to an OS 102 that is version v1, and to respective models 1 to N of the switch 22-1.

A method for generating a port profile using the format of another vendor from a port profile of a given vendor format is described below. Namely, as illustrated in FIG. 6A, a case is considered wherein the operator defines rules for directly generating port profiles using other vendor formats from each port profile of plural switch vendors. However, there is a need for the operator to predefine rules for each different vendor combination. As illustrated in FIG. 6A, when there are 4 vendor types for example, there is a need for the user to predefine 6 rules R1 to R6.

Therefore, in the exemplary embodiment, as illustrated in FIG. 6B, the operator defines rules RA to RD for generating the port profiles 112 to 118 of each of the switches from the master port profile and vice versa. As illustrated in FIG. 6B, for example when there are 4 vendor types, 4 rules RA to RD are sufficient. There are accordingly fewer predefined rules when using a master port profile than in the case described with reference to FIG. 6A.

Port profiles PPA, PPB serve as an example of usage mode data of the present invention, and the master port profile PPM serves as an example of standardized usage mode data of the present invention, and the rules are an example of association data of the present invention.

A case is considered here where the VM 17 is migrated in sequence from the server 12 connected to the vendor A switch 22-1, to the server 14 connected to the vendor B switch 22-2, and to a server, not illustrated in the drawings, connected to a vendor C switch, not illustrated in the drawings. The port profile format needs to be modified at each of the migrations of the VM 17 to the server 12, to the server 14, and to the server not illustrated in the drawings. FIG. 4A illustrates processing to generate the port profiles of the vendor B and vendor C formats from a port profile that uses the vendor A format. At step S1 the VM 17 is set on the server 12 as illustrated in FIG. 1. For the VM 17 to communicate with another VM, the user uses the PP operation GUI 74 and inputs data for port profile creation. The child PP generation section 64 generates the port profile PPA using the vendor A format (see (A) in FIG. 9) based on the input data, and the PP setting section 60 sets the generated port profile PPA on the switch 22-1. Namely, the port profile PPA is stored associated with the identification data of the port 20-1 in the memory 24-1 of the switch 22-1. Note that the port profile is also stored in the PPDB 79.

When the port profile PPA has been created at step S1, at step S1-1 the master PP generation section 62 generates the master port profile MPPA from the port profile PPA based on the rules described above. (B) in FIG. 4 illustrates an example of the processing at step S1-1. At step 142 the master PP generation section 62 reads from the rule definition section 78 the rule for the generation of the master port profile from the vendor A format port profile of the switch 22-1. At step 144 the master PP generation section 62 generates the master port profile MPPA using the rules described above and the contents of the port profile PPA.

The contents of the processing at step 144 will be described in detail with reference to FIG. 9. From the above rules, the master PP generation section 62 is able to confirm that “switchport trunk allowed vlan add” in the port profile PPA corresponds to “TaggedVLAN” in the master port profile PPM. The “100” provided associated with “switchport trunk allowed vlan add” in the port profile PPA is associated with “TaggedVLAN” in the master port profile PPM.

Moreover, from the above rules, the master PP generation section 62 is able to confirm that “qos cos” in the port profile PPA corresponds to “QoSCoS” in the master port profile PPM. The “5” provided associated with “qos cos” in the port profile PPA is associated with “QoSCoS” in the master port profile PPM.

After the master port profile MPPA has been generated as described above, at step S2 in FIG. 4A, the user updates the port profile PPA through the child PP generation section 64 in accordance with, for example, changes in the usage method of a port for communication with the VM 17. The port profile PPA is updated to a port profile PPA1. At step S2-1 the master PP generation section 62 reflects the updated contents in the master port profile MPPA, based on the rules using similar processing to that illustrated in (B) in FIG. 4. The master port profile MPPA becomes the master port profile MPPA1.

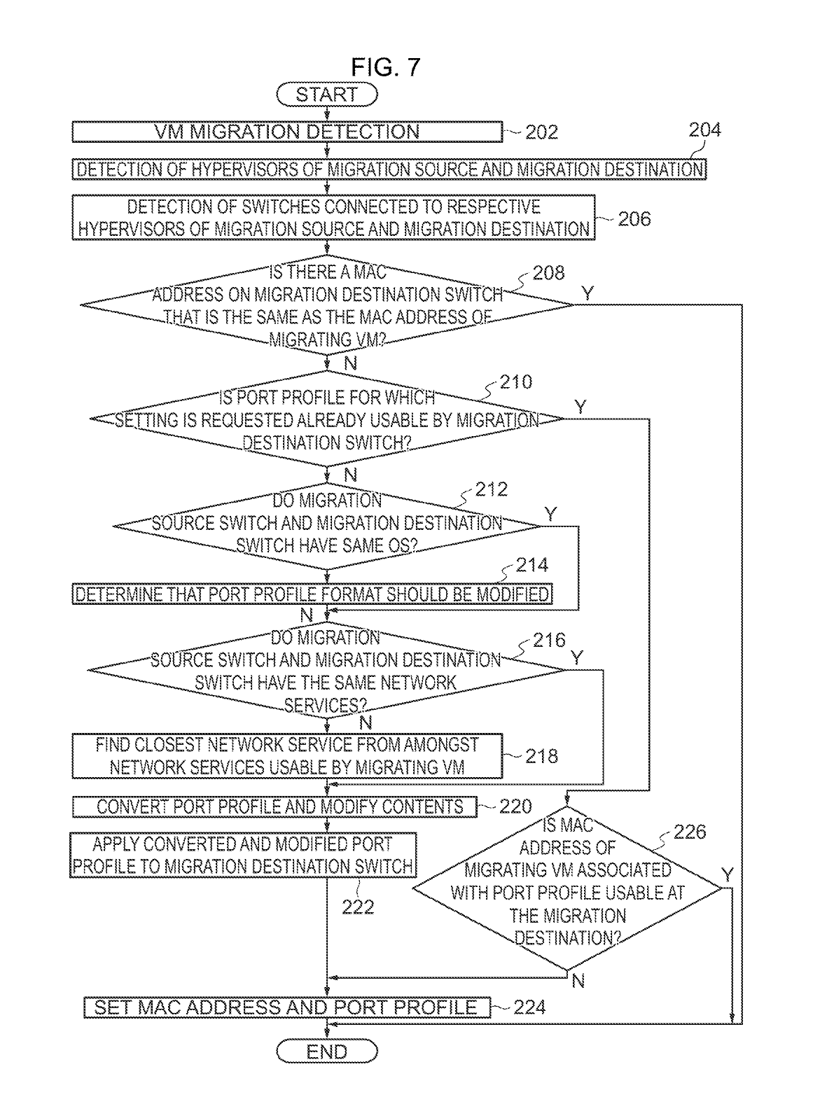

When the VM 17 is migrated to the server 14 that is connected to the switch 22-2 as described above, at step S3-1 the master PP generation section 62 generates a port profile PPB for the switch 22-2 from the master port profile MPPA1. A more detailed description will be given later (see FIG. 7).

At step S4, when the user updates the port profile PPB as described above in accordance with, for example, a change in the usage method of the port, at step S4-1 the master PP generation section 62 generates a master port profile MPPB1 using similar processing to that illustrated in (B) in FIG. 4.

The VM 17 that has been migrated to the server 14 of the switch 22-2 as described above is then migrated to the server, not illustrated in the drawings, connected to the vendor C switch, not illustrated in the drawings. When this occurs, at step S5-1 the master PP generation section 62 generates a port profile PPC with the switch C format from the master port profile MPPB 1. The port profile PPC is generated using similar processing to that used at step S3-1. Note that there are cases in which steps S2 and S4 of FIG. 4A are not executed. Steps S2-1 and S4-1 are therefore not executed, with the port profile PPB generated from the master port profile MPPA following the processing of step S1-1 when the VM 17 has been migrated to the server 14.

Moreover, the master port profile MPPB is generated at step S4-1 at the timing when the port profile PPB is updated. However, after the processing of step S3-1, the master port profile MPPB can be generated from the port profile PPB using similar processing to that used at step S1-1. In cases where the VM 17 is again migrated to another server, a port profile PPC can be generated from the master port profile MPPB using the processing of step S5-1.

FIG. 7 illustrates an example of a flow of port profile generation processing (steps S3-1 and S5-1 in FIG. 4A) for generating a port profile with the switch format from the master port profile. Namely, explanation is given regarding an example of a case in which the VM 17 on the server 12 is migrated to the server 14 (step S3-1 of FIG. 4A) as illustrated in FIG. 1 and FIG. 8. At step 202, the VM migration detection section 72 detects the migration of the VM. Namely, the user inputs instruction data to the management device 10 to instruct migration of the VM 17, through the input device 38 of the management device 10. When the instruction data is input to the management device 10, the VM migration detection section 72 detects the input of the instruction data and detects the VM migration.

At step 204 the network configuration management section 66 detects the hypervisors 15, 16 of the VM 17 migration source and migration destination servers 12, 14. Firstly, the instruction data includes respective identification data identifying the migration source server 12 and the migration destination server 14 of the VM 17. Moreover, data regarding the hypervisors 15, 16 and the switches 22-1, 22-2 are stored in the switch configuration data storage section 80. The processing of step 204 is thereby executed based on the respective identification data identifying the servers 12, 14 included in the instruction data, and on data of the hypervisors 15, 16 and data of the switches 22-1, 22-2 stored in the switch configuration data storage section 80. At step 206 the network configuration management section 66 detects the switches 22-1, 22-2 that are connected to the hypervisors 15, 16 on the migration source side and the migration destination side of the VM. Note that step 204 may be omitted, and the switches 22-1, 22-2 may be detected based on identification data that identifies the servers 12, 14 that is included in the instruction data.

At step 208 the MAC address duplication detection section 68 detects whether or not a MAC address the same as the MAC address communicated by the migrated VM 17 is stored in the memory 24-2 of the migration destination side switch 22-2. As illustrated in FIG. 13, the VMs 17, 19 are provided on the server 12, with the VMs 17, 19 in communication with another VM. A single virtual local area network is built that includes the VMs 17, 19 and the other VM. Moreover, each of the MAC addresses (100, 200) used by VMs 17, 19 and the other VM are stored associated with port profile PPA in the memory 24-1 of the switch 22-1. In cases in which the VMs 17, 19 are migrated to the server 14, MAC addresses (100, 200) used in communication with each of the migrating VMs 17, 19 would not usually be present in the migration destination switch 22-2. However, there are cases where the user stores the MAC addresses (100, 200) in the memory 24-2 of the switch 22-2 in error. In such cases, the MAC address duplication detection section 68 determines whether or not the MAC addresses (100, 200) used in communication with the migrating VMs 17, 19 are stored within the memory 24-2 of the migration destination switch 22-2.

When the determination result at step 208 is an affirmative determination, port profile generation processing terminates since there is a mistake by a user. However, the MAC addresses (100, 200) for communication with migrating VMs 17, 19 are usually not stored in the memory 24-2 of the migration destination switch 22-2. In such cases the determination result at step 208 is therefore a negative determination, and port profile generation processing transitions to step 210.

At step 210 the PP acquisition section 56 and the PP detection section 58 perform processing to determine whether or not the port profile PPA for which setting is requested is already usable by the migration destination switch 22-2. Namely, specifically, the PP acquisition section 56 first acquires the port profile PPA of the VM 17 migration source side switch 22-1. The PP detection section 58 then determines whether or not a port profile with the same contents as the acquired port profile PPA is present in the migration destination side switch 22-2.

Note that the formats of the port profile PPA of the migration source side switch 22-1 and the port profile PPB of the migration destination side switch 22-2 differ from each other. The PP detection section 58 is therefore unable to make a direct comparison between the port profile PPA and the port profile PPB. However, at step S1-1 (step S2-1) of FIG. 4A, the master port profile MPPA is generated from the port profile PPA of the migration source side switch 22-1. The port profile PPB of the migration destination side switch 22-2 is thereby generated from the master port profile MPPA (MPPA1) obtained from step S1-1 (step S2-1) in FIG. 4A based on the rules described above. Determination is then made as to whether or not a port profile with the same contents as the contents of the generated port profile PPB is stored in the memory 24-2 of the migration destination side switch 22-2. In cases where a port profile with the same contents as the contents of the generated port profile PPB is stored in the memory 24-2 of the switch 22-2, the determination result at step 210 is an affirmative determination. In such cases, port profile generation processing then transitions to step 226. In cases where a port profile with the same contents as the contents of the generated port profile PPB is not present in the memory 24-2 of the switch 22-2, the determination result at step 210 is a negative determination. In such cases, port profile generation processing then transitions to step 212.

At step 212 the child PP generation section 64 determines whether or not the model and the OS of the migration source side switch 22-1 and the migration destination side switch 22-2 of the VM 17 are the same as each other based on the data acquired at step 206. In cases where both the model and the OS of the switch 22-1 and the switch 22-2 are the same as each other, the determination result at step 212 is an affirmative determination. The port profiles therefore need not be converted based on differences in model and OS, and so the processing at step 214 is skipped, and port profile generation processing transitions to step 216.

However, when the model or the OS or both the model and the OS of the switch 22-1 and the switch 22-2 differ from each other, the expression formats of the port profiles differ. There is accordingly a need to convert the port profile formats based on the differences in model and/or OS. Therefore, at step 214, it is determined that the child PP generation section 64 should convert the port profile formats based on the differences in model and/or OS.

At step 216 the child PP generation section 64 determines whether or not the network services of the VM 17 migration source and the VM 17 migration destination switches 22-1, 22-2 are the same as each other. When the determination result at step 216 is a negative determination, at step 218 the child PP generation section 64 selects the network service closest to the network service of the VM 17 migration source switch 22-1 from the network services of the switch 22-2. Detailed explanation follows regarding contents of the processing of steps 216, 218.

The vendors of the switches 22-1, 22-2 are different vendors; however, there are cases in which the vendors of the switches 22-1, 22-2 are the same and the contents of network services identified by the same identification data differ. Explanation follows regarding the example of the network service QoS. Namely, firstly, when the ports 20-1, 20-2 of the switches 22-1, 22-2 forward data, the data is temporarily stored and the temporarily stored data is then forwarded. There are limitations to the amount of forwarding data that can be temporarily stored on the ports 20-1, 20-2. Therefore, in cases in which for example communication is performed between plural VM pairs through the same port 20-1 at the same time, each VM would simultaneously attempt to forward data, at an amount that would exceed the maximum amount of data that can be temporarily stored on the port 20-1. Therefore, any data that exceeds the maximum amount of data that can be temporarily stored by the port 20-1 would not be forwarded.

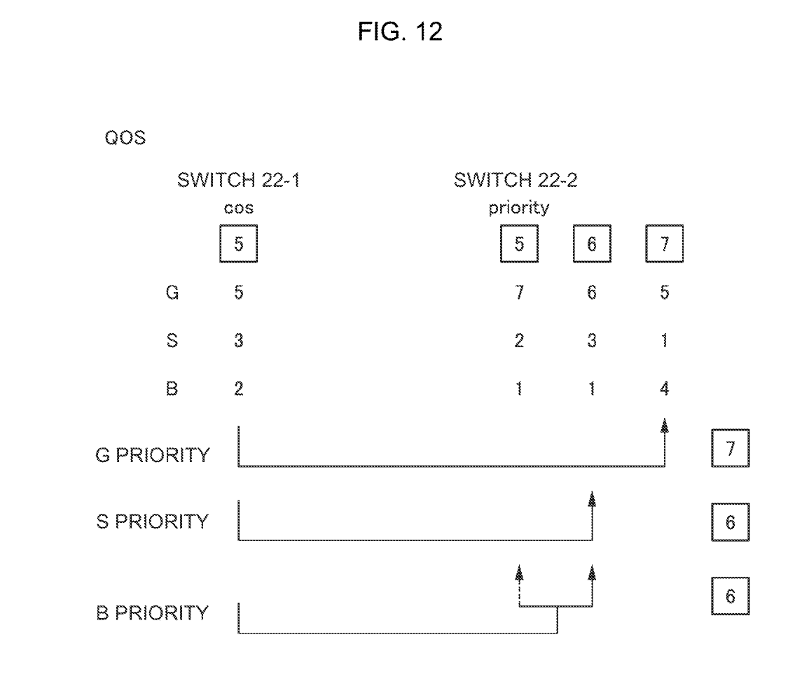

The QoS therefore specifies a ratio of the data amounts that can be forwarded through the port 20-1 by each VM pair. For example, the QoS sets the respective VMs with first rank (G), second rank (S), and third rank (B) data forwarding amounts in the ratio 5:3:2. For example, in the example illustrated in FIG. 12, a “5” identifying that G:S:B=5:3:2 is included in the switch 22-1. Moreover, for example when the VMs using the port 20-1 to forward data are a first VM, a second VM, and a third VM, then the amounts of data that can be temporarily forwarded are set with a ratio of 5:3:2 for the first VM, the second VM, and the third VM.

As described above, even when the vendors of the switches 22-1, 22-2 are the same, the QoS identified by the “5” in the switch 22-2 may also be G:S:B=7:2:1. Accordingly, a second rank (S) is set for the VM 17, and although data can be forwarded at a ratio of 3/10 until the VM 17 is migrated to the server 14, the ratio becomes 2/10 due to the migration of the VM 17 to the server 14.

The child PP generation section 64 selects a QoS with the second rank (S) set to a ratio close to 3/10 out of the plural QoS of the switch 22-2, so as to enable continuation of data forwarding at a ratio of 3/10 as far as possible. Namely, the child PP generation section 64 acquires the QoS data of the switch 22-2. As the QoS of the VM 17 migration source side switch 22-1, a “5” is acquired that identifies G:S:B=5:3:2 in the switch 22-1 as illustrated in FIG. 12. At step 216 the child PP generation section 64 determines whether or not G:S:B is 5:3:2 for the QoS acquired from the migration destination side switch 22-2. In cases where at least one of G, S or B of the QoS differs between the migration source side switch 22-1 and the migration destination side switch 22-2, the determination result of step 216 is a negative determination. Namely, as illustrated in FIG. 12, the QoS identified by 5 is G:S:B=5:3:2 for the switch 22-1; however, the QoS identified by “5” is G:S:B=7:2:1 for the switch 22-2. Negative determination is therefore made at step 216. Port profile generation processing then transitions to step 218.

At step 218 the child PP generation section 64 selects the identification data for the QoS closest to the QoS identified by 5 in the switch 22-1 from the QoS identification data of the switch 22-2. The criteria for determining whether or not a QoS from amongst the plural QoS of the switch 22-2 is close to the switch 22-1 QoS, is a priority ranking pre-input by the priority ranking input section 70. For example, a first case (VM=VM1 (see FIG. 11)) is considered where the priority ranking input section 70 inputs prioritizing with G as the first priority ranking (Prio. 1). In the example illustrated in FIG. 12, G is 5 in the switch 22-1, and the QoS identification data 7 in the switch 22-2, corresponding to a G of 5, is therefore selected. In a second case (VM=VM2 (see FIG. 11)) where the priority ranking input section 70 inputs prioritizing with S as the first priority ranking, S is “3” in the switch 22-1, and the QoS identification data 6 in the switch 22-2 is therefore selected. A third case (VM=VM3 (see FIG. 11)) where the priority ranking input section 70 inputs prioritizing B is considered. B of the switch 22-1 is 2, and B in switch 22-2 is 1 for QoS identification data 5, 6 and is 4 for QoS identification data “7”. Of 1 and 4, 1 is the closest to 2. However, there are two QoS that designate B to 1. As illustrated in FIG. 11, VM3 is input prioritizing with S as the second priority ranking (Prio. 2) after the first priority ranking (Prio. 1) B. After B, the QoS identification data is selected preferentially on the basis of S. In the example illustrated in FIG. 12, S is 3 in the QoS of the switch 22-1, and in the switch 22-2 the QoS for which S is 3 is the QoS identified by the identification data 6. Thus, in the third case, the identification data 6 is selected.

At step 220, the child PP generation section 64 converts the expression formats of the port profile, and modifies the contents of the network service.

First, explanation is given regarding conversion of the port profile expression formats. As described above, when the port profile of the vendor A is created, the master port profile (MPPA) is generated in advance from the port profile (PPA) in accordance with the rules as illustrated in FIG. 4 (refer to step S1). At step 220 the child PP generation section 64 reads the rule from the rule definition section 78 to generate the vendor B format port profile from the vendor A port profile. In accordance with the read rules, the child PP generation section 64 generates the port profile PPB that corresponds to vendor B from the master port profile (MPPA).

Namely, the child PP generation section 64 is able to confirm from the above rules that “TaggedVLAN” in (C) in FIG. 9 corresponds to “port-profile 10 vlan tag” in (B) in FIG. 9. The child PP generation section 64 then associates the “100” associated with “TaggedVLAN” of the master port profile PPM with “port-profile 10 vlan tag” of the port profile PPB.

Moreover, the child PP generation section 64 is able to confirm from the above rules that “QoSCoS” in (C) in FIG. 9 corresponds to the expression format “port-profile 10 qos priority” in (B) in FIG. 9. The child PP generation section 64 then initially associates the “5” associated with “QoSCoS” in the master port profile PPM with the “port-profile 10 qos priority” in the port profile PPB. As described above, when negative determination has been made at step 216, and at step 218 the network service closest to the network service of the VM migration source network service is selected from the network services of the switch 22-2, and “6” is applied associated with “port-profile 10 qos priority” in place of the initially associated “5” as illustrated in FIG. 12.

At step 222 the PP setting section 60 applies (stores) the converted and content-modified port profile to the switch 22-2. At the stage when only the port profile PPB is applied it is unclear which VMs are using the port profile PPB. At step 224 the PP setting section 60 associates the MAC address (100) used in communication with the VM 17 with the port profile PPB. The processing at step 224 is described with reference to FIG. 13. In the example illustrated in FIG. 13, the VM 17 that communicates using the MAC address 100, and the VM 19 that communicates using the MAC address 200, use the port profile PPA at the switch 22-1. One possible network is built including the VM 17, the VM 19, and another VM that communicates with the VM 17 and the VM 19. As illustrated in (A) in FIG. 13, when the VM 17 is migrated to the switch 22-2, the generated port profile PPB on the switch 22-2 is applied at step 222. At the point when the port profile PPB is applied, it is unclear which VMs are using the port profile PPB. However, at step 224 the MAC address and the port profile are associated with one another, and the MAC address 100 used in communication between the VM 17 and the other VM is therefore associated with the port profile PPB after execution of step 224.

Next, a case is considered in which after the VM 17, the VM 19 is also migrated to the server 14 that corresponds to the switch 22-2. At step 208 negative determination is made, and at step 210 it is determined whether or not the port profile for which setting is requested is usable by the migration destination switch 22-2. The port profile PPA used by the VM 19 is already stored on the switch 22-2 as the port profile PPB as a result of the migration of the VM 17. Affirmative determination is accordingly made at step 210.

When affirmative determination has been made at step 210, port profile generation processing transitions to step 226. At step 226 the child PP generation section 64 determines whether or not the MAC address (200) used in communication with the migrating VM 19 is applied in connection with the port profile PPA that is usable by the migration destination side switch 22-2. As described above, affirmative determination is made at step 210 when the VM 19 is migrated. At the stage when affirmative determination is made at step 210, the port profile PPB used by the VM 19 is not usually associated with the MAC address (200) used in communication with the VM 19. Thus negative determination is made at step 226, and at step 224 the PP setting section 60 associates the MAC address (200) used in communication with the VM 19 with the port profile PPB. Note that when affirmative determination is made at step 226, port profile generation processing is terminated.

Explanation follows regarding advantageous effects of the exemplary embodiment.

According to the exemplary embodiment, when a VM on a given server is migrated to another server, there are cases in which the port profile format of the switch connected to the source server are different to the port profile format of the switch connected to the migration destination server. However, since the rules described above are predefined, the exemplary embodiment exhibits the advantageous effect of enabling the generation of a port profile with a different format (a master port profile) from the port profile.

Moreover, there are two methods of converting the port profile formats. In a first case rules for generating the port profile format of another vendor from the port profile format of a particular vendor are defined for each vendor. In a second case rules are defined for the generation of a master port profile from a port profile with a different format. In the first case, it is necessary to have rules for the generation of port profiles of all different formats from a particular port profile. In contrast, in the second case, it is sufficient to define a rule for generating a master port profile for each differing port profile format. Thus, when the second case is adopted, the exemplary embodiment exhibits the advantageous effect of enabling a reduction in the number of user created rules. The exemplary embodiment exhibits an additional advantageous effect of enabling the generation of a port profile with the required format from a master port profile. Thus, the exemplary embodiment exhibits the advantageous effect of enabling communication to continue in the same manner as before migration, even when a VM is migrated to a server connected to a switch of a different vendor.

According to the exemplary embodiment, in cases where the contents of the network service differ, the network service closest to the VM migration source network service is selected from the network services in the migration destination switch. Thus, the exemplary embodiment has an advantageous effect of enabling the port at the migration destination side to be used with a network service close to the network service of the VM migration source.

Moreover, it is determined (step 210) whether or not the port profile for which setting is requested is usable by the migration destination side switch, and when determined that the port profile is usable by the migration destination side switch, the port profile is set on the migration destination side switch. Thus, the exemplary embodiment has an advantageous effect of enabling the prevention of duplicate port profiles being set.

The MAC address of a migrating VM is not usually associated with the port profile of the migration destination side switch or stored in memory. However, a case where the MAC address of a migrating VM is associated with the port profile and stored in the memory of the migration destination side switch may arise as a result of a mistake by a user. According to the exemplary embodiment, it is determined (step 208) whether or not the MAC address used in communication with the migrating VM is stored in the memory of the migration destination side switch. In cases where the MAC address used in communication with the migrating VM is not stored in the memory of the migration destination side switch, the MAC address for use in communication with the migrating VM is stored in the memory of the migration destination side switch. Thus, the exemplary embodiment exhibits the advantageous effect of enabling the setting of duplicate MAC addresses to be avoided.

Explanation follows regarding modified examples of the exemplary embodiment.

According to the exemplary embodiment, in cases where the VM is migrated, and the migration destination side switch port profile has different formats from the VM migration source, an attempt is made to generate a port profile for the migration destination. However, the present invention is not limited to cases where a VM is migrated. Namely, as described above, the formats of the port profiles differ according to the switch model and OS. As an example of a modification, a master port profile is generated from the switch port profile in accordance with the switch model and OS based on the rules described above. Furthermore, in cases where the model or the OS or both are changed, a port profile is generated that corresponds to the format of the changed model and OS.

In the exemplary embodiment, explanation has been given of QoS as an example of a network service; however, processing may be performed in a similar manner with another network service such as access control list (ACL).

An exemplary embodiment exhibits the advantageous effect of enabling usage mode data of a particular format to be generated from usage mode data of a different format.

All cited documents, patent applications and technical standards mentioned in the present specification are incorporated by reference in the present specification to the same extent as if the individual cited documents, patent applications and technical standards were specifically and individually incorporated by reference in the present specification.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A computer-readable recording medium, having stored therein a program for causing a computer to execute a usage mode data generation process, the process comprising:
(a) reading from a storage device association data associating each of a plurality of different expression formats of component data and a standardized expression format which can be converted to each of the plurality of different expression formats, each of the plurality of different expression formats corresponding to each type of a plurality of relay devices, the plurality of relay devices having a connector and relaying communication through the connectors between a plurality of virtual computers that each operate on a data processing device, the component data being included in a usage mode data which is referenced by the relay device, the usage mode data being data to set a usage mode of the connector when the communication through the connectors between a plurality of virtual computers; and
(b) based on the association data read at (a), generating, according to the standardized expression format, standardized usage mode data containing component data from first usage mode data that is usage mode data for a first virtual computer included in the plurality of virtual computers and that contains component data for the connector in a first relay device with the type of a first type expressed in a first expression format corresponding to the first relay device.

2. The computer-readable recording medium of claim 1, wherein the process further comprises (c), when the first virtual computer is being migrated from a first data processing device connected to the first relay device to a second data processing device that is connected to a second relay device with the type of a second type, based on the association data read at (a), generating second usage mode data including component data in a second expression format corresponding to the second relay device from the standardized usage mode data corresponding to the first usage mode data.

3. The computer-readable recording medium of claim 2, wherein the process further comprises:
(d) determining whether or not the second usage mode data generated at (c) is usable in the second relay device;
(e) in cases in which it is determined at (d) that the second usage mode data generated at (c) is usable in the second relay device, determining whether or not the second usage mode data is associated with an address that identifies the communication by the first virtual computer; and
(f) in cases in which it is determined at (d) that the second usage mode data generated at (c) is not associated with the address, associating the second usage mode data with the address.

4. The computer-readable recording medium of claim 3, wherein the process further comprises:
(g) prior to determining whether or not the second usage mode data generated at (c) is usable in the second relay device, determining whether or not the address is associated in the second relay device; and
in (d), in cases in which it is determined at (g) that the address is not associated in the second relay device, determining whether or not the second usage mode data generated at (c) is usable in the second relay device.

5. The computer-readable recording medium of claim 3, wherein:
the second relay device includes an association memory that associates together and stores the second usage mode data and the address;
in (d), determining whether or not the second usage mode data is usable in the second relay device by determining whether or not the second usage mode data is stored in the association memory;
in (e), determining whether or not the second usage mode data is associated with the address by determining whether or not the second usage mode data and the address are associated together and stored in the association memory; and
in (f), associating the second usage mode data with the address by associating the second usage mode data and the address together and storing in the association memory.

6. The computer-readable recording medium of claim 4, wherein:
the second relay device includes an association memory that associates together and stores the second usage mode data and the address;
in (g), determining whether or not the address is associated in the second relay device by determining whether or not the address is stored in the second relay device; and
in (d), determining whether or not the second usage mode data is usable in the second relay device by determining whether or not the second usage mode data is stored in the association memory.

7. The computer-readable recording medium of claim 1, wherein the process further comprises (h) in cases in which the first usage mode data has changed, reflecting the changed contents in the standardized usage mode data, based on the association data.

8. The computer-readable recording medium of claim 2, wherein the process further comprises (i), generating from the second usage mode data another standardized usage mode data according to the standardized expression format.

9. The computer-readable recording medium of claim 8, wherein the process further comprises (j), in cases in which the second usage mode data has changed, reflecting changed contents that have changed from the changed second usage mode data in the other standardized usage mode data, based on the association data.

10. The computer-readable recording medium of claim 2, wherein:
identification data indicating content of each component data is included in the usage mode data; and
when the second usage mode data is being generated in (c), in cases in which the identification data of the second expression format is the same as the identification data of the first expression format but content expressed in the second expression format is different from content expressing identification data of the first expression format, using as the identification data of the second expression format content that out of a plurality of identification data expresses identification data that is identification data closest to content expressing identification data of the first expression format.

11. The computer-readable recording medium of claim 1, wherein
an expression format of the component data differs in manufacturer (vendor) of the relay device, or in model of the relay device, or in operating software (OS) employed when the relay device relays communication, or in a combination thereof

12. A usage mode data generation method comprising:
(a) reading from a storage device association data associating each of a plurality of different expression formats of component data and a standardized expression format which can be converted to each of the plurality of different expression formats, each of the plurality of different expression formats corresponding to each type of a plurality of relay devices, the plurality of relay devices having a connector and relaying communication through the connectors between a plurality of virtual computers that each operate on a data processing device, the component data being included in a usage mode data which is referenced by the relay device, the usage mode data being data to set a usage mode of the connector when the communication through the connectors between a plurality of virtual computers; and
(b) based on the association data read at (a), generating according to the standardized expression format standardized usage mode data containing component data from first usage mode data that is usage mode data for a first virtual computer included in the plurality of virtual computers and that contains component data for the connector in a first relay device with the type of a first type expressed in a first expression format corresponding to the first relay device.

13. The usage mode data generation method of claim 12 further comprising:
(c) when the first virtual computer is being migrated from a first data processing device connected to the first relay device to a second data processing device that is connected to a second relay device with the type of a second type, based on the association data read at (a), generating second usage mode data including component data in a second expression format corresponding to the second relay device from the standardized usage mode data corresponding to the first usage mode data.

14. The usage mode data generation method of claim 13 further comprises:
(d) determining whether or not the second usage mode data generated at (c) is usable in the second relay device;
(e) in cases in which it is determined at (d) that the second usage mode data generated at (c) is usable in the second relay device, determining whether or not the second usage mode data is associated with an address that identifies the communication by the first virtual computer; and
(f) in cases in which it is determined at (d) that the second usage mode data generated at (c) is not associated with the address, associating the second usage mode data with the address.

15. The usage mode data generation method of claim 14 further comprises:
(g) prior to determining whether or not the second usage mode data generated at (c) is usable in the second relay device, determining whether or not the address is associated in the second relay device; and
in (d), in cases in which it is determined at (g) that the address is not associated in the second relay device, determining whether or not the second usage mode data generated at (c) is usable in the second relay device.

16. The usage mode data generation method of claim 14, wherein:
the second relay device includes an association memory that associates together and stores the second usage mode data and the address;
in (d), determining whether or not the second usage mode data is usable in the second relay device by determining whether or not the second usage mode data is stored in the association memory;
in (e), determining whether or not the second usage mode data is associated with the address by determining whether or not the second usage mode data and the address are associated together and stored in the association memory; and
in (f), associating the second usage mode data with the address by associating the second usage mode data and the address together and storing in the association memory.

17. The usage mode data generation method of claim 15, wherein:
the second relay device includes an association memory that associates together and stores the second usage mode data and the address;
in (g), determining whether or not the address is associated in the second relay device by determining whether or not the address is stored in the second relay device; and in (d), determining whether or not the second usage mode data is usable in the second relay device by determining whether or not the second usage mode data is stored in the association memory.

18. The usage mode data generation method of claim 12 further comprises (n) in cases in which the first usage mode data has changed, reflecting the changed contents in the standardized usage mode data, based on the association data.

19. A usage mode data generation device comprising:
a storage section in a relay device that includes a connecting section, the storage section storing association data containing an expression format of component data, the component data being referenced by the relay device to relay communication through the connecting section between a plurality of virtual computers that each operate on a data processing device, having an expression format that corresponds to a type of the relay device, and including respective usage mode data to set a usage mode for the communication of the connecting section for each of the plurality of virtual computers, and the association data containing a standardized expression format that is compatible to a plurality of different expression formats and is associated with the expression format of the component data;
a processor; and
a memory storing instructions, which when executed by the processor perform a procedure, the procedure including,
(a) reading the association data from the storage device, and
(b) based on the association data read at (a), generating according to the standardized expression format standardized usage mode data containing component data from first usage mode data that is usage mode data for a first virtual computer included in the plurality of virtual computers and that contains component data for the connector in a first relay device with the type of a first type expressed in a first expression format corresponding to the first relay device.

20. The usage mode data generation device of claim 19, wherein the process further comprises (c), when the first virtual computer is being migrated from a first data processing device connected to the first relay device to a second data processing device that is connected to a second relay device with the type of a second type, based on the association data read at (a), generating second usage mode data including component data in a second expression format corresponding to the second relay device from the standardized usage mode data corresponding to the first usage mode data.
